(19) United States
(12) Patent Application Publication
(10) Pub. No.: US 2012/0193934 A1
(43) Pub. Date: Aug. 2, 2012

(54) Sunshade Assembly Having a Buffer Unit

(75) Inventor: Paul Lin, Tainan City (TW)

(73) Assignee: MACAUTO INDUSTRIAL CO. LTD., Tainan City (TW)

(21) Appl. No.: 13/016,232

(22) Filed: Jan. 28, 2011

(51) Int. Cl. B60J 3/00

(52) U.S. Cl. 296/97.8

(57) ABSTRACT

A sunshade assembly includes a housing having a top opening, a winding shaft mounted rotatably in the housing, a sunshade cloth wound around the winding shaft, a pull rod connected to one end of the sunshade cloth and disposed external to the top opening, and a guide unit including a tubular casing mounted below the housing, and a guide rod extending downward from the pull rod and slidable in the tubular casing. A buffer unit includes a driven member mounted to the guide rod, and a buffer mounted to the tubular casing. When the sunshade cloth is moved by the winding shaft to a wound position from a stretched position, the guide rod is moved downward along with the pull rod until the driven member contacts the buffer, thereby retarding a downward movement speed of the guide rod to reduce a winding speed of the sunshade cloth.

### BACKGROUND OF THE INVENTION

1. Field of the Invention

The invention relates to a sunshade, and more particularly to a sunshade assembly that is adapted to be installed on a side window of a vehicle and that has a sunshade cloth which can be wound automatically.

2. Description of the Related Art

Referring to FIG. 1, a conventional sunshade assembly 1 includes a housing 11 having a top opening 111, a winding shaft 12 mounted rotatably in the housing 11, a sunshade cloth 13 wound around the winding shaft 12, a pull rod 14 connected to one end 131 of the sunshade cloth 13 that is distal from the winding shaft 12, and a hanging seat 15 for hanging of the pull rod 14 when the sunshade cloth 13 is unwound from the winding shaft 12.

To use the conventional sunshade assembly 1, the user pulls out the sunshade cloth 13 from the housing 11 via the top opening 111, and the pull rod 14 is hung on the hanging seat 15, thereby placing the sunshade cloth 13 in a stretched position. When the pull rod 14 is removed from the hanging seat 15, the sunshade cloth 12 is quickly wound back onto the winding shaft 12. However, the quick winding of the sunshade cloth 12 back onto the winding shaft 12 can result on impact between the pull rod 14 and the housing 11 due to inertia. The impact may generate noise and cause vibration in the components of the conventional sunshade assembly. Hence, the conventional sunshade assembly 1 lacks sophistication, and is not suitable for use in luxury cars.

### SUMMARY OF THE INVENTION

Therefore, the object of the present invention is to provide a sunshade assembly that has a buffer unit which can prevent production of noise and vibration when a sunshade cloth is moved from a stretched position to a wound position.

According to this invention, a sunshade assembly comprises a sunshade unit, a guide unit, and a buffer unit. The sunshade unit includes a housing having a top opening, a winding shaft mounted rotatably in the housing, a sunshade cloth wound around the winding shaft, and a pull rod connected to one end of the sunshade cloth that is distal from the winding shaft and disposed external to the top opening. The guide unit includes a tubular casing mounted below the housing and extending in a top-bottom direction, and a guide rod extending downward from the pull rod and slidable in the tubular casing. The buffer unit includes a driven member mounted to the guide rod, and a buffer mounted to the tubular casing. When the sunshade cloth is moved by the winding shaft to a wound position from a stretched position external to the housing, the guide rod is moved downward along with the pull rod until the driven member contacts the buffer to provide a buffer resistance to the guide rod, thereby retarding a downward movement speed of the guide rod to reduce a winding speed of the sunshade cloth.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional sunshade assembly;

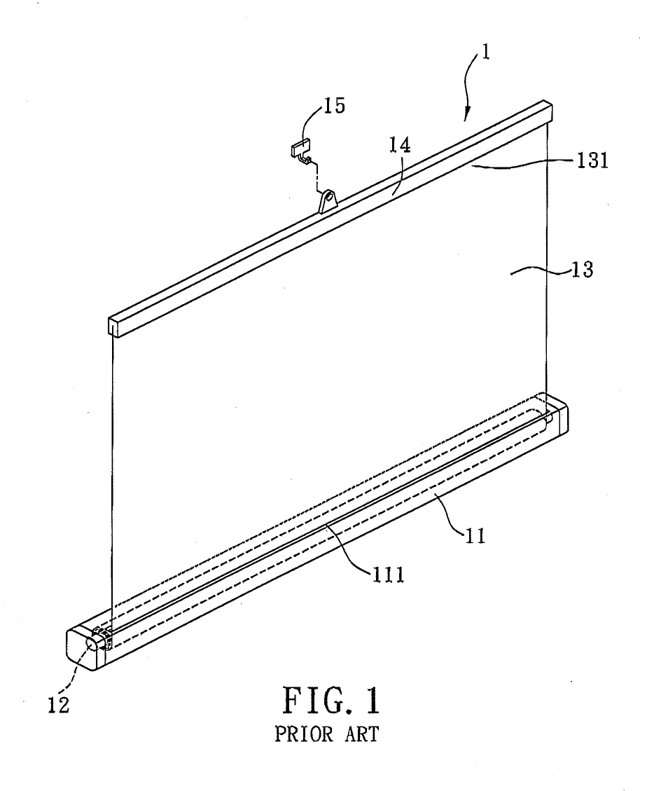

FIG. 2 is a partially sectional view of a sunshade assembly according to the first preferred embodiment of the present invention;

FIG. 3 is a fragmentary enlarged sectional view of the first preferred embodiment;

FIG. 4 is a fragmentary enlarged sectional view of a sunshade assembly according to the second preferred embodiment of the present invention; and

FIG. 5 is a fragmentary enlarged sectional view of a sunshade assembly according to the third preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

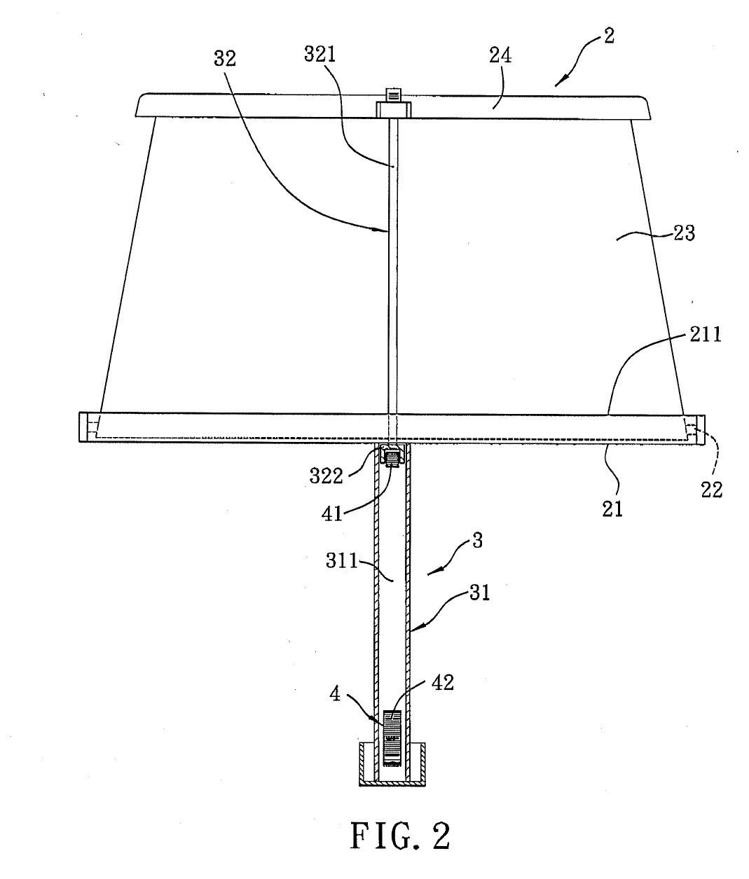

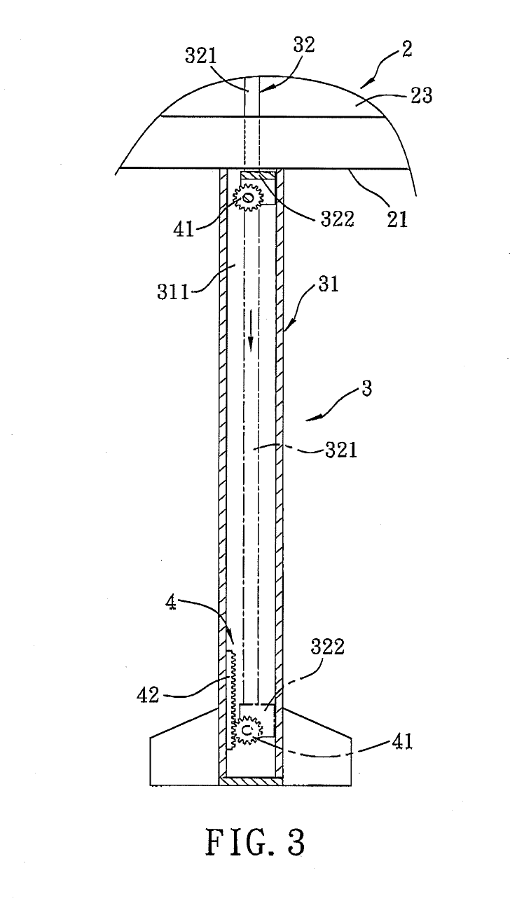

Referring to FIGS. 2 and 3, a sunshade assembly according to the first preferred embodiment of the present invention is shown to comprise a sunshade unit 2, a guide unit 3, and a buffer unit 4. The sunshade assembly of the present invention is adapted to be installed on a door (not shown) of a vehicle to cover a corresponding side window (not shown).

The sunshade unit 2 includes a housing 21 having a top opening 211, a rewindable winding shaft 22 mounted rotatably in the housing 21, a sunshade cloth 23 unwindably wound around the winding shaft 22, and a pull rod 24 connected to one end of the sunshade cloth 23 that is distal from the winding shaft 22 and disposed external to the top opening 211. The sunshade unit 2 may further include at least one biasing element (not shown) having one end that is fixed, and another end connected to the winding shaft 22. The biasing element is rotatable along with the winding shaft 22 to provide a winding biasing force to the winding shaft 22 along a winding direction. That is, in the absence of an external force, the sunshade cloth 23 is automatically wound into the housing 21 by the winding shaft 22.

The guide unit 3 includes a tubular casing 31 mounted below the housing 21 and extending in a top-bottom direction, and a guide rod 32 extending downward from the pull rod 24. The tubular casing 31 defines a guide space 311 extending in a top-bottom direction. The guide rod 32 is slidable within the guide space 311, and includes a rod body 321 connected to the pull rod 24, and a slide piece 322 mounted to a bottom end of the rod body 321. The rod body 321 and the slide piece 322 may be made integrally as one piece, may be threadedly connected to each other, or may be connected to each other through other suitable connecting methods. In an alternative embodiment, the number of the tubular casing 31 and the guide rod 32 of the guide unit 3 may be increased as desired to enhance stability of upward and downward movement of the guide rod 32. Hence, the number of the tubular casing 31 and the guide rod 32 is not limited to the aforesaid disclosures.

The buffer unit 4 includes a driven member 41 and a buffer 42. In this embodiment, the driven member 41 includes a pinion mounted rotatably to the slide piece 322. Alternatively, the driven member 41 may be directly mounted to the bottom end of the rod body 321, so that the slide piece 322 may be dispensed with. The buffer includes a rack bar extending in a top-bottom direction and mounted to a bottom portion of the tubular casing 31 within the guide space 311 to mesh with the pinion when the guide rod 32 moves downward. The rack bar is used to retard rotation of the pinion. Alternatively, the driven member 41 may be a damping gear or a roller, and the buffer 42 may be an elongated bar having a rough surface. The buffer 42 may similarly provide a damping force to the driven member 41. In this embodiment, the buffer 42 may be made of silicone or rubber, and the driven member 41 may be made of a material harder than the buffer 42, such as plastic. Alternatively, the driven member 41 may be made of silicone or rubber, and the buffer 42 may be made of plastic. As long as one of the driven member 41 and the buffer 42 is made of a soft material, and the other one of the driven member 41 and the buffer 42 is made of a hard material, the two parts may cooperatively interfere with each other to reduce noise and to provide good damping effect, the materials of the driven member 41 and the buffer 42 are not limited to the aforesaid disclosure.

In use, the sunshade cloth 23 is movable between a stretched position externally of the housing 21, as shown in FIG. 2, and a wound position disposed within the housing 21, as shown in FIG. 3. If stretching of the sunshade cloth 23 is desired to cover sunlight, the pull rod 24 is pulled upward by a user to pull the sunshade cloth 23 out of the housing 21 via the top opening 211. The guide rod 32 moves upward along with the pull rod 24, and the winding shaft 22 stores a winding force. The pull rod 24 is moved upward until it is hooked and positioned to a hooking seat (not shown), thereby placing the sunshade cloth 23 to the stretched position shown in FIG. 2. Alternatively, the sunshade cloth 23 may be designed such that when it is pulled upward, it may stop at any desired level or height, so that the hooking seat and the pull rod 24 may be dispensed with.

If it is desired to shift the sunshade cloth 23 from the stretched position shown in FIG. 2 to the wound position shown in FIG. 3, the pull rod 24 is first disengaged from the hooking seat. Through a winding action of the winding shaft 22, the pull rod 24 and the guide rod 32 can move downward quickly until the pinion of the driven member 41 meshes with the rack bar of the buffer 42. Because of the buffer resistance provided by the buffer 42, the speed of the driven member 41 can be reduced to slow the downward movement speed of the guide rod 32. Hence, a winding speed of the sunshade cloth 23 can be gradually reduced until the guide rod 32 comes to a full stop and the sunshade cloth 23 is in the wound position, and the guide rod 32 is prevented from directly bumping onto the housing 21.

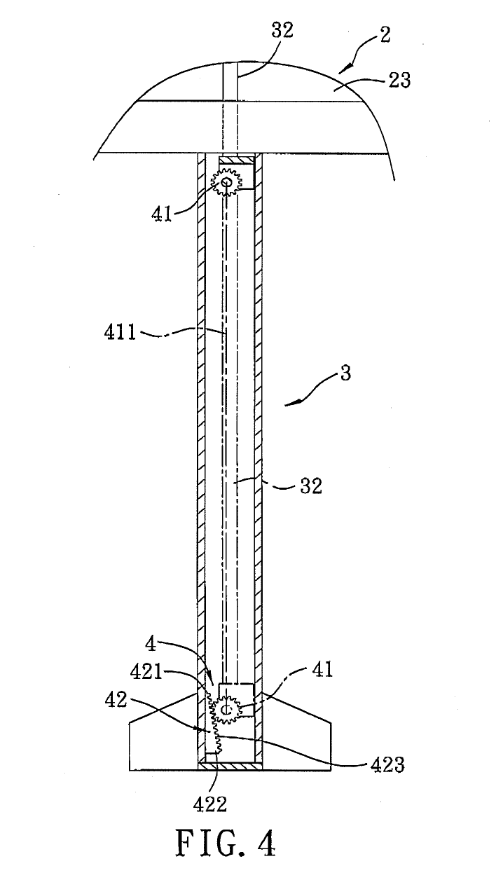

Referring to FIG. 4, a sunshade assembly according to the second preferred embodiment of the present invention is shown to be similar to the first preferred embodiment. However, in this embodiment, the rack bar of the buffer 42 has a top end 421, a bottom end 422, and an inclined toothed surface 423 formed between the top and bottom ends 421, 422. The inclined toothed surface 423 is inclined with respect to a linear moving path 411 of the pinion of the driven member 41, and is angled from the top end 421 to the bottom end 422 toward the linear moving path 411.

When the sunshade cloth 23 is shifted from the stretched position to the wound position, the guide rod 32 and the driven member 41 move downward along the linear moving path 411 until the pinion of the driven member 41 meshes with the rack bar of the buffer 42 and moves from the top end 421 to the bottom end 422. Because the inclined surface 423 is angled toward the linear moving path 41L from the top end 421 to the bottom end 422, a pushing force on the driven member 41 and a corresponding resistance gradually increases as the driven member 41 moves near the end of the winding operation. Hence, the present invention not only can gradually reduce a winding speed of the sunshade cloth 23, but the winding operation can also be tightened until a full stop is reached.

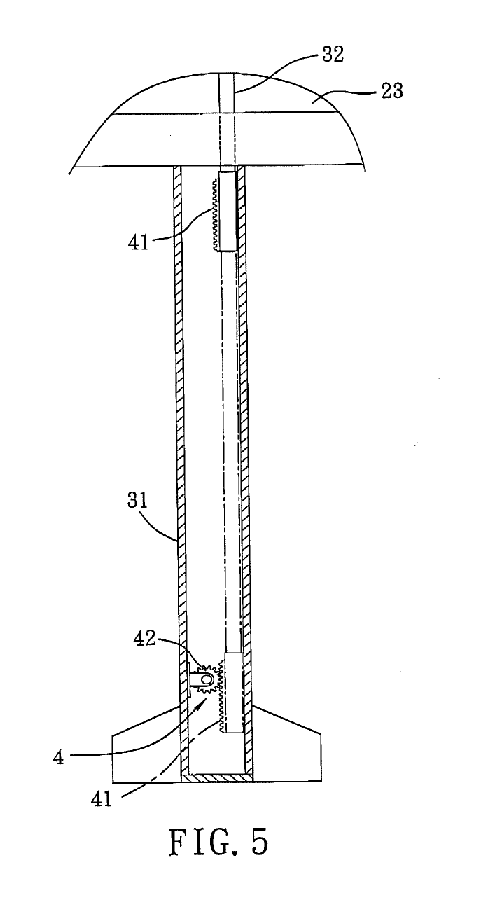

Referring to FIG. 5, a sunshade assembly according to the third preferred embodiment of the present invention is shown to be similar to the first preferred embodiment. However, in this embodiment, the driven member 41 includes a rack bar that extends in a top-bottom direction and that is fixed to the bottom end of the guide rod 32. The buffer 42 includes a pinion mounted rotatably to the bottom portion of the tubular casing 31 to mesh with the rack bar of the driven member 41 when the guide rod 32 moves downward. The effect of reducing the winding speed of the sunshade cloth 23 can be similarly achieved using the third preferred embodiment of the present invention.

From the aforesaid description of the sunshade assembly of the present invention, it is apparent that by mounting the guide unit 3 with the buffer unit 4 to provide a buffer resistance, the downward moving speed of the guide rod 32 and the speed of winding the sunshade cloth 23 can be slowed when the sunshade cloth 23 nears its complete winding onto the winding shaft 22, thereby preventing the guide rod 32 from impacting other components that will produce noise and vibration. Hence, the present invention can effectively minimize noise and vibration during winding of the sunshade cloth 23 to enhance the sophistication of the product.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A sunshade assembly comprising:
a sunshade unit including a housing having a top opening, a winding shaft mounted rotatably in said housing, a sunshade cloth wound around said winding shaft, and a pull rod connected to one end of said sunshade cloth that is distal from said winding shaft and disposed external to said top opening;
a guide unit including a tubular casing mounted below said housing and extending in a top-bottom direction, and a guide rod extending downward from said pull rod and slidable in said tubular casing; and
a buffer unit including a driven member mounted to said guide rod, and a buffer mounted to said tubular casing;
wherein, when said sunshade cloth is moved by said winding shaft to a wound position from a stretched position external to said housing, said guide rod is moved downward along with said pull rod until said driven member contacts said buffer to provide a buffer resistance to said guide rod, thereby retarding a downward movement speed of said guide rod to reduce a winding speed of said sunshade cloth.

2. The sunshade assembly of claim 1, wherein one of said driven member and said buffer includes a pinion, and the other one of said driven member and said buffer includes a rack bar to mesh with said pinion.

3. The sunshade assembly of claim 2, wherein said driven member includes a pinion mounted rotatably to a bottom end of said guide rod, and said buffer includes a rack bar extending in a top-bottom direction within a bottom portion of said tubular casing to mesh with said pinion when said guide rod moves downward.

4. The sunshade assembly of claim 2, wherein said driven member includes a rack bar fixed to a bottom end of said guide rod, and said buffer includes a pinion mounted rotatably to a bottom portion of said tubular casing to mesh with said rack bar when said guide rod moves downward.

5. The sunshade assembly of claim 3, wherein said rack bar of said buffer has top and bottom ends, and an inclined toothed surface formed between said top and bottom ends, said inclined toothed surface being inclined with respect to a linear moving path of said pinion, and being angled toward said linear moving path of said pinion.
